(19) United States
(12) Patent Application Publication
(10) Pub. No.: US 2025/0234243 A1
(43) Pub. Date: Jul. 17, 2025

(54) SYSTEMS, METHODS, AND DEVICES FOR XRM PDU SET QOS PARAMETERS ENHANCEMENT

(71) Applicant: Apple Inc., Cupertino, CA (US)

(72) Inventors: Sudeep MANITHARA VAMANAN, Uttenreuth (DE); Ping-Heng KUO, London (GB); Ralf ROSSBACH, Munich (DE); Krisztian KISS, Rancho Santa Fe, CA (US); Waqar ZIA, Munich (DE)

(21) Appl. No.: 19/019,113

(22) Filed: Jan. 13, 2025

Related U.S. Application Data
(60) Provisional application No. 63/620,701, filed on Jan. 12, 2024.

(51) Int. Cl. H04W 28/02; H04W 80/10

(52) U.S. Cl. CPC H04W 28/0268; H04W 80/10

(57) ABSTRACT

One or more of the techniques described herein include solutions for enabling a user equipment (UE) to identify uplink (UL) protocol data unit (PDU) sets such that PDU set quality of service (QoS) parameters may be applied to PDU sets by a base station, core network (CN), and other network devices. Also described herein are solutions for a CN to provide protocol descriptions for PDU sets to base stations, enabling base stations to apply different QoS parameters based on an ability of a UE to identify PDU sets, and enabling a base station to dynamically apply different PDU set delay budgets (PSDB) to downlink (DL) and uplink (UL) traffic based on the size of PDU sets.

### CROSS REFERENCE TO RELATED APPLICATIONS

This application claims the benefit of U.S. Provisional Application No. 63/620,701, filed Jan. 12, 2024, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another. Some scenarios may involve enabling or configuring a UE to communicate with a network at a desired quality of service (QoS).

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an overview of extended reality (XR) and media (XRM) protocol data unit (PDU) set quality of service (QoS) parameters enhancement according to one or more implementations described herein.

FIG. 2 is a diagram of an example network according to one or more implementations described herein.

FIG. 3 is a diagram of an example network architecture for XRM PDU set QoS parameters enhancement according to one or more implementations described herein.

FIG. 4 is a diagram of an example process for PDU set QoS parameters enhancement according to one or more implementations described herein.

FIG. 5 is a diagram of an example process for PDU set QoS parameters enhancement according to one or more implementations described herein.

FIG. 6 is a diagram of an example process for PDU set QoS parameters enhancement according to one or more implementations described herein.

FIG. 7 is a diagram of an example process for PDU set QoS parameters enhancement according to one or more implementations described herein.

FIG. 8 is a diagram of an example process for PDU set QoS parameters enhancement according to one or more implementations described herein.

FIG. 9 is a diagram of an example of components of a device according to one or more implementations described herein.

FIG. 10 is a block diagram illustrating components, according to one or more implementations described herein, able to read instructions from a machine-readable or computer-readable medium (e.g., a non-transitory machine-readable storage medium) and perform any one or more of the methodologies discussed herein.

FIGS. 11-15 are diagrams of example process for PDU set QoS parameters enhancement according to one or more implementations described herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. Telecommunication networks may also include UEs and base stations communicating with a core network (CN). UEs base stations, and CNs may implement various techniques and communications standards for enabling these entities to discover one another, establish and maintain connectivity, and exchange information in an ongoing manner. Objectives of such techniques may include ensuring a certain degree of quality and reliability is maintained as information is exchanged between UEs, base stations, and CNs.

XRM services may be characterized as requiring or preferring dataflows characterized by higher data rates and lower latencies and therefore may be associated with a higher quality of service (QoS) than other types of network services. XR services may include a variety of technologies that blend the real world with the digital or virtual reality. This may include virtual reality (VR), augmented reality (AR), mixed reality (MR), and so on. XR services may be part of, or an example of, XRM services, which may also include streaming music, streaming video, calling services, etc. For simplicity, XR services, XRM services, and similar services may be collectively, or individually, referred to herein as “XRM services” and the like.

A protocol data unit (PDU) may include a single unit of information exchanged between entities of the same layer (e.g., a physical (PHY) layer, media access control (MAC) layer, etc.). A PDU session may include a logical connection and communication session established between the UE and a CN. The PDU session may be established according to policy and charging control (PCC) rules relating to subscription profiles, QoS, traffic handling, and more. Establishing a PDU session may include multiple QoS flows, and each QoS flow may have different QoS parameters. A QoS flow may be identified by a QoS flow identifier (QFI) and may be the finest granularity of QoS differentiation in a PDU Session. Traffic with the same QFI within a PDU session may receive the same forwarding, scheduling and treatment by the network.

A PDU set, as used herein, may include PDUs carrying a payload of one unit of information generated at a media or application level (e.g., one or more frames, video slices, etc.). A PDU set may include a “PDU Set”. The PDUs of a PDU set may be transmitted within the same QoS flow and subject to the same QoS parameters. PDU sets may be used to address the integrated and differentiated transmission of media units. The concept of a PDU set may involve the collection of packets or PDUs that collectively carry the payload of a single media unit. A PDU set may be handled by a network according to PDU set QoS parameters. Examples of QoS parameters for a PDU set may include a PDU set delay budget (PSDB), a PDU set error rate (PSER), a PDU set integrated handling information (PSIHI), and a PDU set importance (PSI).

A PSBD may define an upper bound for a delay that a PDU set may experience while being transferred between a UE and an N6 termination point at a user plane function (UPF) of a CN (e.g., a duration between a reception time of a first PDU of a PDU set (at an N6 termination point for downlink (DL) communications or at a UE for uplink (UL) communications) and a reception time of all PDUs of the PDU set (at the UE for DL communications or the N6 termination point for UL communications). An N6 termination point may include a reference point between the UPF and a data network. A PSER may include an upper bound for a rate of non-congestion related to PDU set losses. The purpose of the PSER may be to allow for appropriate link layer protocol configurations (e.g. radio link control (RLC) and hybrid automatic repeat request (HARQ) in radio access network (RAN)). A PSIHI may indicate whether all PDUs of the PDU set are needed for the usage of the PDU set by the application layer on the receiver side of a data flow. A PSI may indicate a relative importance of the PDU set (e.g., how important the PDU set is relative to other PDUs or PDU sets).

The way in which a base station, or other type of RAN device, handles a PDU set may be based, at least in part, on QoS parameters associated with the PDU set. For example, if a base station does not receive a PDU of a PDU set within a specified amount of time, the base station may discard the entire PDU set because of a PSIHI associated with the PDU set. Also, if the base station may is not able to transmit a PDU of a PDU set, then the base station may drop the remaining PDUs of a PDU set when a PSIHI is requested for a QoS flow. As another example, if a base station is experiencing network congestion that exceeds a specified threshold, the base station may discard a PDU set based on a PSI associated with the PDU set. As such, identifying PDU sets may better enable networks to properly manage and prioritize PDUs based on QoS parameters associated with PDU sets.

While currently available technologies may provide theoretical tools for RANs to manage UL PDU sets according to PDU set QoS parameters, currently available technologies fail to provide adequate solutions for enabling a UE to identify a UL PDU set from among the PDUs produced by the UE. As described herein, identifying a UL PDU set may include indicating to the network which PDUs are part of a particular PDU set. As a result, a base station and other network devices may be unable to properly apply PDU set QoS parameters to UL traffic, which may undermine an ability of the network to support certain applications and services, such as XRM services.

One or more of the techniques described herein include solutions for enabling a UE to identify UL PDU sets such that PDU set QoS parameters may be appropriately applied by a base station, CN, and other network devices. In turn, these techniques may enable a telecommunications network to operate with greater precision, efficiency, and robustness, in addition to providing better support for XR services, XRM services, and other types of services, because PDUs may be handled in accordance with the value and nature of the PDUs and conditions of the network.

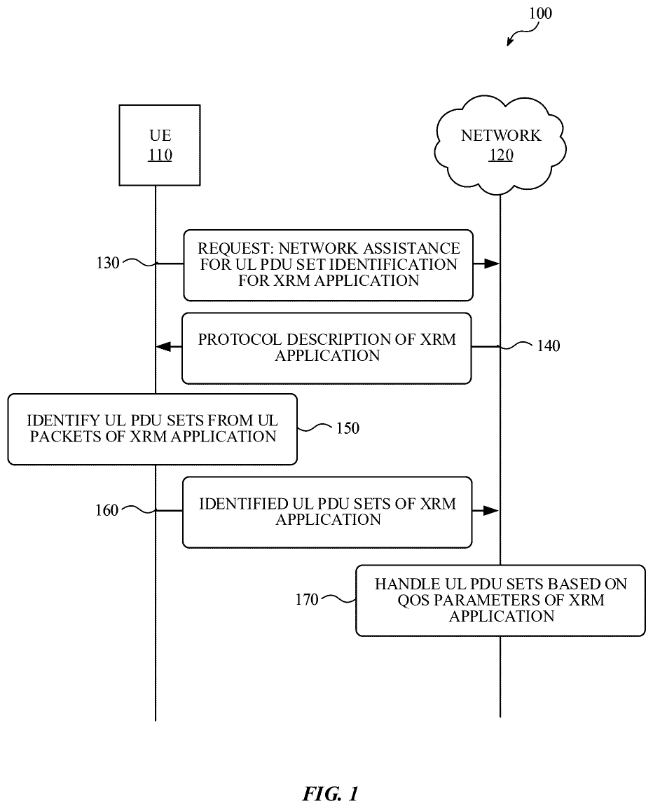

FIG. 1 is a diagram of an example overview 100 of XRM PDU set QoS parameters enhancement according to one or more implementations described herein. As shown, example overview 100 may include UE 110 and network 120. Depending on the implementation, network 120 may be implemented by a base station, one or more core network functions (e.g., a session management function (SMF), or another type of network entity.

UE 110 may send a request for network assistance information for PDU set identification (at 130). This may occur during a PDU session establishment procedure or a PDU session modification procedure associated with an XRM application (e.g., when a XRM application begins to transmit data or changes the type or way data is being transmitted). In some implementations, UE 110 may first determine that UE 110 is capable of PDU set identification and/or verify that an upper layer cannot provide UE with the assistance information. In response to the request, network 120 may determine, based on one or more factors or conditions, to send protocol description information to UE 110 (at 140). Examples of such factors or conditions may include UE capability information sent to network 120, UE subscription data stored in a core network entity, the type of application associated with the PDU session, etc.

The protocol description may indicate how UE 110 may identify UL PDU sets from among UL packets produced and transmitted by UE 110. For example, the protocol description may identify a transport layer protocol and/or characteristics (e.g., header extensions) of a transport layer protocol used by the XRM application. UE 110 may use the protocol description information to identify PDU sets from among UL packets produced by UE 110 (at 150). UE 110 may communicate the identified PDU sets to network 120 (at 160), and network 120 may identify QoS parameters associated with the XRM application and handle or process the PDU sets according to the QoS parameters (at 170). As such, one or more of the techniques described herein may enhance how UL PDU sets of XRM applications may be identified and how QoS parameters may be appropriately applied to UL PDU sets.

The techniques described herein also include other features and solutions. For example, the techniques described herein include solutions for a CN to provide protocol descriptions for PDU sets to base stations, enabling base stations to apply different QoS parameters based on an ability of a UE to identify PDU sets, and enabling a base station to dynamically apply different PSDBs to DL and UL traffic based on the size of PDU sets. Accordingly, many additional features and benefits of the techniques described herein are discussed below with reference to the examples and figures that follow.

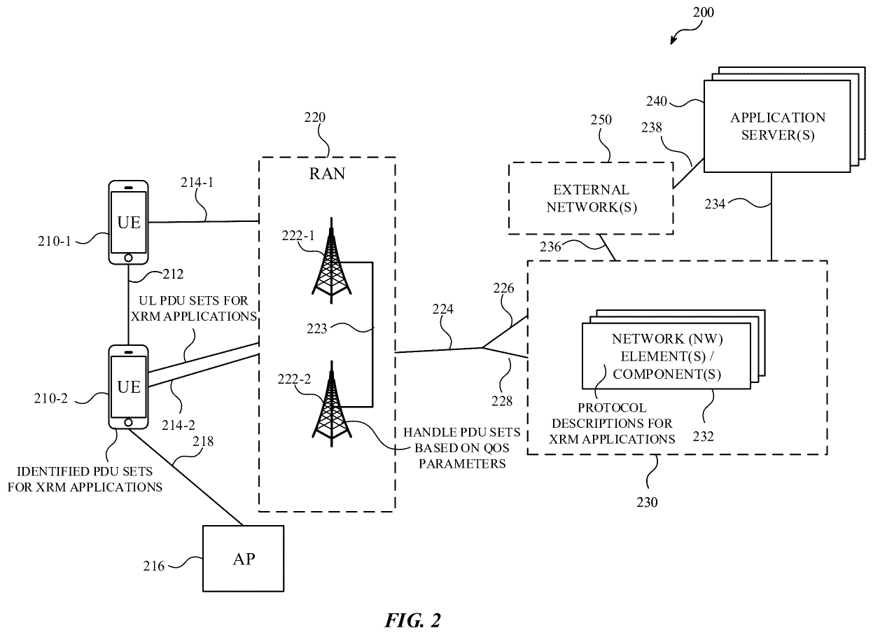

FIG. 2 is an example network 200 according to one or more implementations described herein. Example network 200 may include UEs 210-1, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, wireless handsets, tablet computers, wearable devices, laptop computers, desktop computers, etc. In some implementations, UEs 210 may include internet-of-things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210 may communicate with RAN node 222 to request SL resources. RAN node 222 may respond to the request by providing UE 210 with a dynamic grant (DG) or configured grant (CG) regarding SL resources. A DG may involve a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

As described herein, UE 210 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells. RAN nodes 222 may be referred to herein as base station 222.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) may be performed at any of the RAN nodes 222 based on channel quality information fed back from any of UEs 210. The downlink resource assignment information may be sent on the PDCCH used for (e.g., assigned to) each of UEs 210.

One or more of the techniques, described herein, may enable XRM PDU set QoS parameters enhancement as described herein. For example, UE 210 may identify UL PDU sets based on protocol description information for an XRM application. The protocol description may be received from SMF 320 or RAN 220 (e.g., a base station 222 of RAN 220). In another example, RAN 220 may apply a configurable PSDB to UL PDU sets and DL PDU sets based on a size of the PDU sets. In another example, RAN 220 apply different types of QoS parameters to UL traffic from UE 210 based on whether UE 210 is capable of identifying PDU sets. In yet other examples, one or more of the functions or entities of CN 230 may participate in enabling UL PDU sets to be identified and enabling QoS parameters to be applied to PDU sets.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VoIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

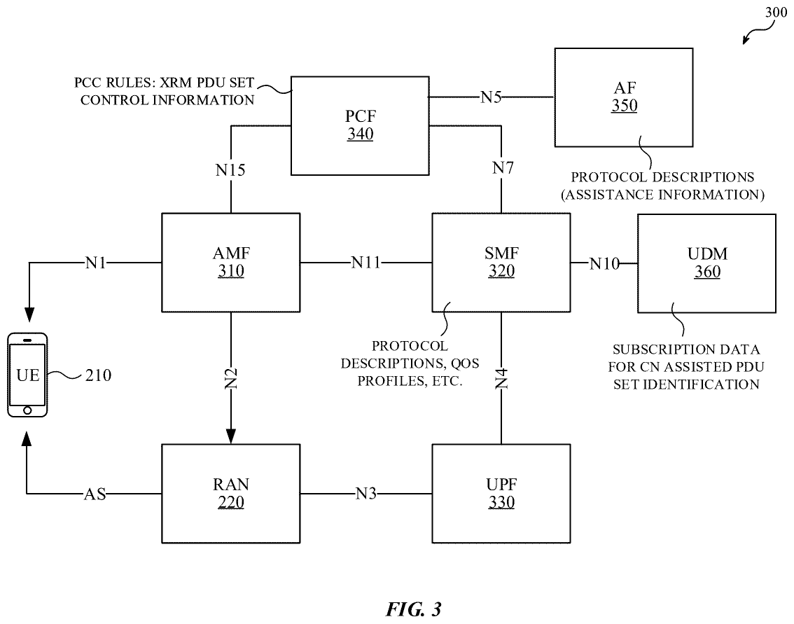

FIG. 3 is a diagram of example network architecture 300 for PDU set QoS parameters enhancement according to one or more implementations described herein. As shown, example architecture 300 may include UE 210, RAN 220, access and mobility management function (AMF) 310, session management function (SMF) 320, user plane function (UPF) 330), policy control function (PCF) 340, application function (AF) 350, and unified data management (UDM) node 360. RAN 220 may include a base station, gNB, etc. AMF 310, SMF 320, UPF 330, PCF 340, AF 350, and UDM node 360 may be functions of CN 230 and may be implemented by one or more servers in a centralized or distributed networking environment, which may include one or more network virtualization functions. In some implementations, example network architecture 300 may include one or more additional, alternative, and/or differently arranged functions, interfaces, or other features than those shown in FIG. 3.

AMF 310 may communicate with RAN 220 via an N2 interface and UE 210 via an N1 interface. AMF 310 may manage authentication, registration, and other functionalities relating to UEs 210 accessing a telecommunication mobile network. AMF 310 may handle handovers, paging, and other functionality regarding the mobility and communications of UEs 210. AMF 310 may also provide security functionality for authenticating and authorizing UEs 210. AMF 310 may communicate with SMF via an N11 interface, with PCF 340 via an N15 interface, and with UPF 340 via an N4 interface.

SMF 320 may provide PDU session management. To do so, SMF 320 may collect information related to managing a PDU session from various network components (e.g., UPF 330, PCF 340, AF 350, etc.) and control or orchestrate the network components based on a request from AMF 310. SMF 320 may be responsible for establishing, maintaining, and terminating user sessions in CN 230. SMF 320 may manage user plane (UP) resources and interact with UPF 330 to ensure that data packets are correctly routed and forwarded.

SMF 320 may receive PDU session establishment and/or session modification request from UE 210. The request may include an indication for assistance with a UL PDU set identification. The request may also indicate a real-time transport protocol (RTP) header extension and/or transport layer protocol corresponding to the requested assistance. SMF 320 may determine whether a protocol description, corresponding to the request, has been provided by PCF 340 and/or AF 350. The protocol description may include information about the RTP header extensions and/or other protocol features used by an application, and in turn, enable UE 210 to identify PDU sets from UL packets. The protocol description may also, or alternatively, include information about one or more other types of transport layer protocols and/or protocol features used by an application, such that UE 210 may identify PDU sets from UL packets based on how the application uses the transport layer protocol.

SMF 320 may include PDU set protocol descriptions, QoS profiles and parameters, quality flow identifiers (QFIs), and/or one or more additional or alternative types of information to, for example, enable UL PDU sets of a given application or service to be appropriately identified. For example, AF 350 may include protocol descriptions for different types of applications and services supported by the network, such as XR applications and/or XRM applications and services. The protocol descriptions may include information to enable UE 210, base stations 222, and other devices to identify PDU sets within a service data flow. SMF 320 may receive the protocol descriptions from AF 350 via PCF 340, and may provide the protocol descriptions to UE 210, RAN 220, UPF 330, and/or one or more of the devices or entities described herein. In some implementations, the protocol descriptions provided by SMF 320 may be based, at least in part, on rules received from PCF 340.

UPF 330 may communicate with RAN 220 via an N3 interface, PCF 340 via an N7 interface, and SMF 320 via an N11 interface. UPF 330 may operate as a point of connection for PDU sessions between RAN 220 and external data networks (e.g., the Internet or another telecommunication network). UPF 330 may also provide support for packet routing, forwarding, and inspection. UPF 330 may further provide for user plane rule enforcement, QoS handling, UL/DL rate enforcement, and service data flow (SDF) to QoS flow mapping. UPF 330 may communicate with SMF 320 via an N4 interface and with RAN 220 via an N3 interface. PCF 340 may provide policy control and flow-based control functionalities. PCF 340 may include and provide policy charging and control (PCC) rules for applications, data flows, PDU sets, gating, QoS, etc., to SMF 320. PCF 340 may also provide access and mobility management policies to AMF 310. PCF 340 may communicate with SMF 320 via an N7 interface and with AMF 310 via an N15 interface.

UE 210 may send and receive information from RAN 220 via an access stratum (AS) interface. UE 210 may also send and receive PDU set information (e.g., protocol descriptions for PDU set information) from SMF 320 via SM signaling. QoS flow profiles and PDU set protocol descriptions may also be configured from SMF 320 to RAN 220 and UE 210. Each QoS flow profile and/or PDU set protocol description may be associated with a set of QoS parameters that may be part of a QoS profile stored by RAN 220 and updated by AMF 310. Examples of QoS parameters may include a resource type, packet delay budget (PDB), quality flow identifier (QFI), packet error rate (PER), averaging window, and more. AMF 310 may provide UE 210 with QoS rules during a PDU session via a non-access stratum (NAS) protocol or interface.

AF 350 may include a network function configured to manage traffic and QoS assignments, through interaction with the policy elements. AF 350 may expose an application layer for interaction with 5G NFs and network resources. AF 350 may reside in a control plane of a 5G service-based architecture (SBA), and its responsibilities may include: accessing a network repository function (NEF) for retrieving resources, interacting with PCF 340 via an N5 interface, enabling policy control, traffic routing for applications, and providing application services to subscribers.

AF 350 may also, or alternatively, include protocol descriptions and/or assistance information for applications being used by UE 210. AF 350 may provide the protocol descriptions and/or assistance information to directly to UE 210. AF 350 may also, or alternatively, provide protocol description and/or assistance information to one or more other network functions or entities, such as SMF 320. The protocol description and/or assistance information may enable UE 210 to properly identify UL PDU sets. The protocol descriptions and/or assistance information may include PDU set QoS parameters, such as a PSBD, PSER, PSIHI, PSI, and/or one or more other types of information related to ensuring that the network handles the corresponding PDU set appropriately.

UDM node 360 may handle subscription-related information to support the handling of communication sessions. UDM node 360 may store subscription data of UE 210, which may be communicated between the UDM node 360 and the AMF 310 via an N8 interface (not shown). UDM node 360 may communicate with SFM 320 via an N10 interface. UDM node 360 may include two parts, an application functional entity (FE) and a unified data repository (UDR). The UDR may store subscription data and policy data for UDM node 360 and PCF 340, and/or structured data for exposure and application data (including packet flow descriptions (PFDs) for application detection and requested information). UDM node 360 may include a UDM-FE, which may process credentials, perform location management, subscription management, and so on. The UDM-FE may also access subscription information stored in the UDR and perform authentication credential processing, user identification handling, access authorization, registration/mobility management, and subscription management.

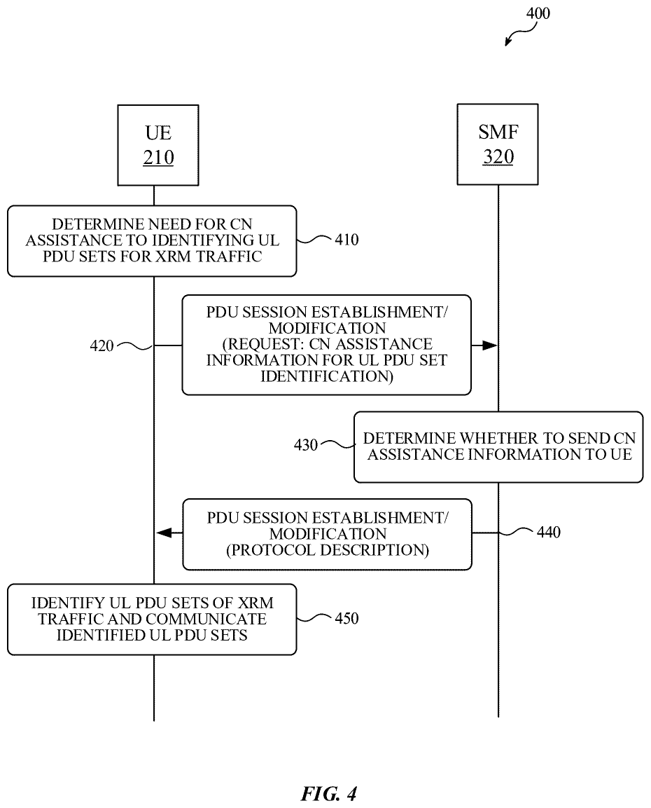

FIG. 4 is a diagram of an example process 400 for PDU set QoS parameters enhancement according to one or more implementations described herein. Process 400 may be implemented by UE 210 and SMF 320. While not shown, the implementation of process 400 may involve one or more additional entities or devices, such as RAN 220, base station 222, AMF 310, UPF 330, PCF 340, and/or AF 350. Additionally, or alternatively, some or all of process 400 may be performed by one or more other systems, devices, or entities, including one or more of the devices of FIGS. 2-3. Further, process 400 may include one or more fewer, additional, differently ordered and/or arranged operations than those shown in FIG. 4. In some implementations, some or all of the operations of process 400 may be performed independently, successively, simultaneously, etc., of one or more of the other operations of process 400. As such, the techniques described herein are not limited to a number, sequence, arrangement, timing, etc., of the operations or processes depicted in FIG. 4.

Process 400 may include a technique for PDU set QoS parameters enhancement using SM signaling. As shown, process 400 may include UE 210 determining a need for CN assistance to identify UL PDU sets for XRM traffic (at 410). XRM traffic may include packets or PDUs associated with an XRM application or service. In some implementation, UE 210 may make this determination based on UE implementation or a higher layer operating system (UE-HLOS) (e.g., an operating system (OS) that runs on an application processor of UE 210). A UE-HLOS may be different from a real-time OS running on a modem or cellular processor of UE 210.

An XRM application may be stored on UE 210. Starting the XRM application (or executing a feature or function of the XRM application) may prompt, trigger, or cause UE 210 to determine a need for CN assistance to identify UL PDU sets from the packets produced by the XRM application. In other implementations, UE 210 may determine a need for CN assistance to identify UL PDU sets in response to detecting or determining that the XRM application is causing UL packets to be produced, a PDU session to be established, and/or a PDU sessions to be modified.

Process 400 may include UE 210 sending a request to SMF 320 for CN assistance information for UL PDU set identification (block 420). For example, during or in response to a PDU session establishment procedure or a PDU session modification procedure, UE 210 may send a request to SMF 320 for information that may assist UE 210 in identifying UL PDU sets. In some implementations, this information may be referred to as 5GC assistance information, CN assistance information, protocol description information, etc. UE 210 may send the request as part of session management (SM) signaling. The request from UE 210 may indicate an XRM service or QoS flow associated with the request. The request may be part of a PDU session modification message. In some implementations, UE 210 may generate the request in response to one or more conditions or triggers, such as an XRM application causing UL packets to be produced, a PDU session to be established and/or modified, etc. UE 210 may not be configured to include a request for CN assistance information in response to any or all PDU session establishment or modification procedures.

In some implementations, the request for CN assistance information may specifically indicate one or more RTP header extension and/or transport protocols for which UE 210 is requesting CN assistance information. This may enable SMF 320 to determine whether a protocol description provided by AF 350 includes assistance information for the protocol and/or protocol features indicated by the request. In some implementations, prior to determining a need for CN assistance information, and/or prior to sending a request to SMF 320 for CN assistance information, UE 210 may verify that an upper layer is unable to provide assistance information (e.g., information to enable UE 210 to appropriately identify UL PDU sets). In some implementations, prior to determining a need for CN assistance information, and/or prior to sending a request to SMF 320 for CN assistance information, UE 210 may verify that UE 210 is capable of identifying PDU sets for UL communications. In some implementations, UE 210 may request CN assistance information for PDU set identification as part of a NAS protocol capability and/or mobility management (MM) protocol capability.

Additionally, or alternatively, UE 210 may request CN assistance information for PDU set identification via AS layer signaling (e.g., as UE assistance information, as part of an RRC reconfiguration complete message, etc.). In yet other implementations, whether UE 210 needs CN assistance information for PDU set identification may be part of subscription information store by UDM node 360. Additionally, or alternatively, SMF 320 may communicate with UDM node 360 to determine whether to provide UE 210 with CN assistance information for PDU set identification.

Process 400 may include SMF 320 determining whether to send CN assistance information to UE 210 (block 430). For example, in response to receiving a request for CN assistance information from UE 210, SMF 320 may determine whether to respond to the request by sending UE 210 information that may cause or enable UE 210 to appropriately identify UL PDU sets associated of XRM traffic. This may occur during or as the result of a PDU session establishment or modification procedure. The CN assistance information may include a protocol description. SMF 320 may determine whether to send a protocol description to UE 210 based on UE subscription information (which may be stored by UDM node 360). The UE subscription information may indicate whether UE 210 is permitted to access the protocol description, SMF 320 may also, or alternatively, determine whether to send a protocol description to UE 210 based on one or more PCC rules (which may be stored by PCF 340 and provided to SMF 320).

A protocol description may include information describing one or more parameters or aspects of a protocol (e.g., a transport protocol or an application protocol) used to communicate PDUs through the network. In some implementations, the protocol may be an RTP and the protocol description may indicate or relate to a field, parameter, header extension, or one or more other aspects of the transport protocol. The protocol description may indicate to UE 210 how to mark or identify UL PDU sets of XRM traffic so that the network handles the identified UL PDU sets in accordance with QoS parameters suitable or selected for the XRM application and/or a particular data stream thereof. SMF 320 may determine whether to send CN assistance information

Process 400 may include SMF 320 communicating the protocol description information to UE 210 (block 440). As shown, this may occur during or as the result of a PDU session establishment or modification procedure. Process 400 may include UE 210 receiving the protocol description from SMF 320, using the protocol description information to identify UL PDU sets of XRM traffic, and communicating the identified UL PDU sets (block 450). UE 210 may identify UL PDU sets from UL IP packets by performing the filtering of header and/or payload information with the contents of the protocol description. A protocol description may, for example, indicate that all PDUs having the same timestamp and same payload type belong to one PDU set. As described herein, UE 210 may communicate the identified UL PDU sets to base station 222, and base station 222 may process the identified UL PDU sets in accordance with a corresponding QoS flow and/or one or more QoS parameters (e.g., a PSDB, PSER, PSIHI, etc.). Base station 222 may use UL PDU set QoS parameters (e.g., a PSIHI) to indicate in a DRB that UE 210 should apply pduSet-discard function and drop a PDU set if one of the PDUs in that PDU set has a transmission failure. As another example, base station 222 may use the PSDB to provide sufficient opportunities for UE 210 to transmit a UL PDU set within a permissible time budget.

While not shown, in some implementations, process 400 may include SMF 320 indicating to UE 210 an availability of one or more protocol descriptions. In some implementations, this indication may be on a per QoS flow basis (e.g., certain protocol descriptions may be available for certain QoS flows). In some implementations, upon receiving a request for CN assistance information and determining that CN assistance information (or a protocol description) is not available for a QoS flow associated with the request, SMF 320 may indicate to UE 210 that CN assistance information or a protocol description for the QoS flow is not available. This may be performed as part of a PDU session establishment and/or modification procedure. In some implementations, SMF 320 may provide the protocol description to UE 210 in a subsequent PDU session modification procedure.

In some implementations, the network (e.g., SMF 320) may provide assistance information (e.g., a protocol description) to UE 210 as an information element (IE) within a protocol configuration option (PCO) feature. PCO may enable a network to provide specific configuration information to UE 210. PCO may be exchanged during the establishment of a connection and may be used to convey parameters and configurations that UE 210 may use for proper communication with the network (e.g., appropriately identifying UL PDU sets of XRM traffic).

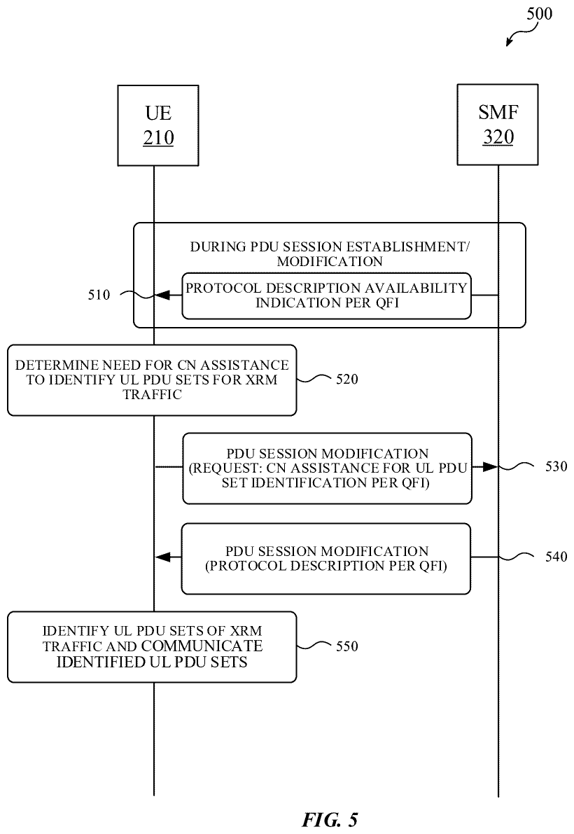

FIG. 5 is a diagram of an example process 500 for PDU set QoS parameters enhancement according to one or more implementations described herein. Process 500 may be implemented by UE 210 and SMF 320. While not shown, the implementation of process 500 may involve one or more additional entities or devices, such as RAN 220, base station 222, AMF 310, UPF 330, PCF 340, and/or AF 350. Additionally, or alternatively, some or all of process 500 may be performed by one or more other systems, devices, or entities, including one or more of the devices of FIGS. 2-3. Further, process 500 may include one or more fewer, additional, differently ordered and/or arranged operations than those shown in FIG. 5. In some implementations, some or all of the operations of process 500 may be performed independently, successively, simultaneously, etc., of one or more of the other operations of process 500. As such, the techniques described herein are not limited to a number, sequence, arrangement, timing, etc., of the operations or processes depicted in FIG. 5.

Process 500 may include a technique for PDU set QoS parameters enhancement using SM signaling with SMF notification. As shown, process 500 may include SMF 320 communicating a protocol description availability indication per QFI (block 510). For example, SMF 320 may provide UE 210 with information describing protocol descriptions that are available on a per QoS flow basis. For example, SMF 320 may provide UE 210 with an indication of protocol descriptions that are available for QoS flows associated with different QFIs. This indication may be provided by SMF 320 during a PDU session establishment procedure or a PDU session modification procedure.

Process 500 may include UE 210 determining whether CN assistance is needed to identify UL PDU sets for XRM traffic (block 520). XRM traffic may include packets or PDUs associated with an XRM application or service. UE 210 may determine whether CN assistance is needed based on UE implementation. For example, an XRM application may be stored on UE 210. Starting the XRM application (or executing a feature or function of the XRM application) may prompt, trigger, or cause UE 210 to determine a need for CN assistance to identify UL PDU sets from the packets produced by the XRM application. In other implementations, UE 210 may determine a need for CN assistance to identify UL PDU sets in response to detecting or determining that the XRM application is causing UL packets to be produced, a PDU session to be established, and/or a PDU sessions to be modified.

Process 500 may include UE 210 sending a request to SMF 320 for CN assistance information for UL PDU set identification per QFI (block 520). The request may be sent during a PDU session modification procedure. For example, UE 210 may determine that CN assistance information (e.g., a protocol description) is needed for a particular QoS flow. In response, UE 210 may determine whether a QFI of the QoS flow matches a QFI for which a protocol description was indicated as available by SMF 320. Upon determining that the protocol description is available, UE 210 may send a request to SMF 320 for the protocol description. The request may include the QFI of the QoS flow, and SMF 320 may use the QFI to identify the corresponding protocol description and provide the protocol description to UE 210 along with the corresponding QFI. SMF 320 may provide the protocol description as part of the PDU session modification procedure.

Process 500 may include UE 210 receiving the protocol description and corresponding QFI from SMF 320, using the protocol description information and QFI to identify UL PDU sets of QoS flow associated with the QFI, and communicating the identified UL PDU sets (block 550). As described herein, UE 210 may communicate the identified UL PDU sets to base station 222, and base station 222 may process the identified UL PDU sets in accordance with QoS parameters (e.g., a PSDB, PSER, PSIHI, etc.) associated with the QoS flow and/or QFI. In some implementations, SMF 320 may provide the protocol description to UE 210 in a subsequent PDU session modification procedure.

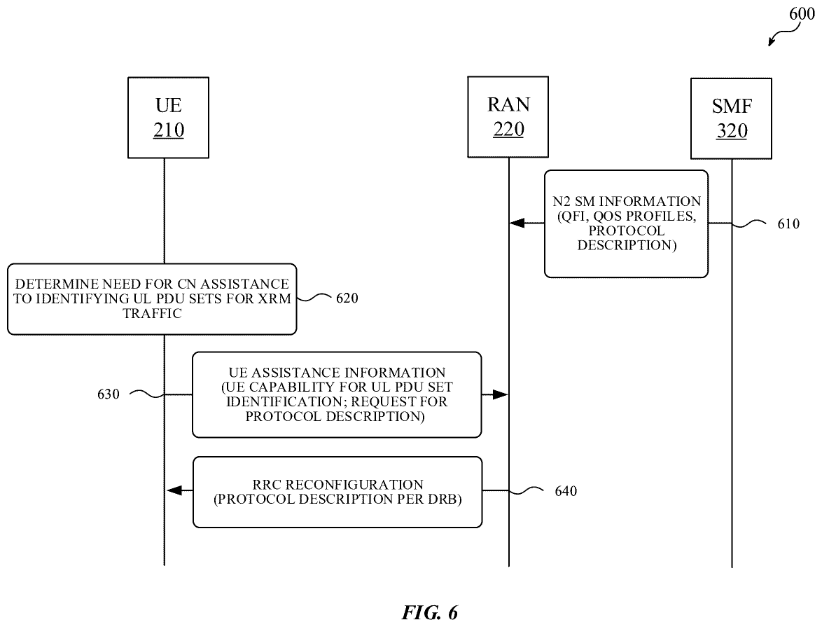

FIG. 6 is a diagram of an example process 600 for PDU set QoS parameters enhancement according to one or more implementations described herein. Process 600 may be implemented by UE 210, RAN 220, and SMF 320. While not shown, the implementation of process 600 may involve one or more additional entities or devices, such as base station 222, AMF 310, UPF 330, PCF 340, and/or AF 350. Additionally, or alternatively, some or all of process 600 may be performed by one or more other systems, devices, or entities, including one or more of the devices of FIGS. 2-3. Further, process 600 may include one or more fewer, additional, differently ordered and/or arranged operations than those shown in FIG. 6. In some implementations, some or all of the operations of process 600 may be performed independently, successively, simultaneously, etc., of one or more of the other operations of process 600. As such, the techniques described herein are not limited to a number, sequence, arrangement, timing, etc., of the operations or processes depicted in FIG. 6.

Process 600 may include a technique for PDU set QoS parameters enhancement using AS signaling to provision protocol descriptions. As shown, process 600 may include SMF 320 providing SM information to RAN 220 (e.g., base station 222, not shown) (block 610). SMF 320 may provide the information via an N2 interface. The information may include QFIs, QoS profiles, protocol descriptions, and/or one or more other types of information. Process 600 may include UE 210 determining a need for CN assistance to identify UL PDU sets for XRM traffic (block 620). UE 210 may also verify that UE 210 is capable of identifying UL PDU sets for XRM traffic and/or verify that UE 210 is not able to identify UL PDU sets for XRM traffic without CN assistance information (e.g., protocol description information).

Process 600 may include UE 210 sending a request to RAN 220 for UE assistance information (block 630). The UE assistance information (UAI) may include UE capability information for UL PDU set identification, an indication or request for a protocol description for UL PDU set identification, etc. The UE capability information may include an indication that UE 210 is capable of identifying UL PDU sets for XRM traffic. In some implementation, UE 210 may request UE assistance information via one message and request a protocol description via another message. The request may indicate a transport protocol, DRB, XRM application, and/or one or more other types of information that may enable RAN 220 to identify an appropriate protocol description to provide to UE 210.

RAN 220 may respond to the message from UE 210 by sending UE 210 protocol description information (block 640). The protocol description information may be provided on a per-DRB basis. For example, the request from UE 210 for a protocol description may include an indication of one or more DRBs. RAN 220 may respond to the request by providing protocol description information for each DRB indicated by UE 210. Additionally, or alternatively, RAN 220 may provide the protocol description information in an RRC message, such as an RRC reconfiguration message.

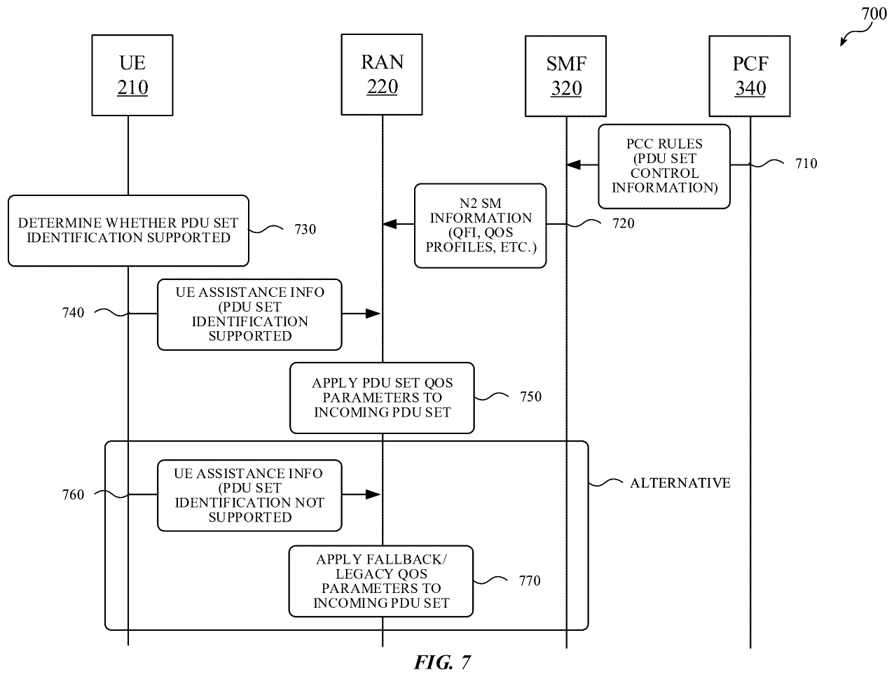

FIG. 7 is a diagram of an example process 700 for PDU set QoS parameters enhancement according to one or more implementations described herein. Process 700 may be implemented by UE 210, RAN 220, SMF 320, and PCF 340. While not shown, the implementation of process 700 may involve one or more additional entities or devices, such as base station 222, AMF 310, UPF 330, and/or AF 350. Additionally, or alternatively, some or all of process 700 may be performed by one or more other systems, devices, or entities, including one or more of the devices of FIGS. 2-3. Further, process 700 may include one or more fewer, additional, differently ordered and/or arranged operations than those shown in FIG. 7. In some implementations, some or all of the operations of process 700 may be performed independently, successively, simultaneously, etc., of one or more of the other operations of process 700. As such, the techniques described herein are not limited to a number, sequence, arrangement, timing, etc., of the operations or processes depicted in FIG. 7.

Process 700 may include a technique for applying QoS parameters on a per-PDU or per-PDU set basis. As shown, process 700 may include PCF 340 communicating PCC rules to SMF 320 (710). The PCC rules may include PDU set control information. Examples of PDU set control information may include quality of service parameters, such as a PDU set delay budget, a PDU set error rate, a PDU set integrated handling indication, etc. In some implementations, different sets of PDU set control information may be associated with different transport protocols, QFIs, QoS flows, DRBs, etc. In some implementations, the PDU set control information may include legacy or fallback QoS parameters for scenarios in which UE 210 provides UL traffic without identifying PDU sets.

Process 700 may include SMF 320 providing SM information to RAN 220 (e.g., base station 222, not shown) (block 720). SMF 320 may provide the information via an N2 interface. The information may include QFIs, QoS profiles, protocol descriptions, and/or one or more other types of information. A QoS profile may include PDU set QoS parameters and corresponding fallback QoS parameters. PDU set QoS parameters may be applicable to scenarios in which UE 210 is capable of identifying UL PDU sets of XRM traffic. Fallback QoS parameters may be applicable to scenarios in which UE 210 is unable to identify UL PDU sets of XRM traffic.

Process 700 may include UE 210 determining whether UE 210 is capable of supporting the identification of UL PDU sets (block 730). UE 210 may make this determination in response to detecting a given condition or trigger, such as executing an XRM application, detecting UL XRM traffic, etc. In some implementations, UE 210 may make this determination in response to a standard procedure for providing RAN 220 with UE capability information.

Process 700 may include UE 210 communicating UE assistance information to RAN 220. The UE assistance information may include an indication of whether UE 210 supports UL PDU set identification for a particular DRB and/or QoS flow. UE 210 may provide UE assistance information dynamically (e.g., based on a trigger, condition, etc.). For example, when an XRM application, or another type of application, starts or stops providing UL traffic requiring PDU set identification, when UE power consumption does not allow for processor- or resource-intensive PDU set identification, etc.

When UE 210 supports the identification of UL PDU sets, UE 210 may provide RAN 220 with UE assistance information that indicates that UE 210 is capable of identifying PDU sets (block 740). This capability may be specific to certain types of applications, services, QoS flows, etc., such as those relating to XRM. In response, RAN 220 may apply PDU set QoS parameters to incoming PDU sets identified by UE 210 (block 750). The QoS parameters may correspond to PDU set QoS parameters received from SMF 230. When UE 210 does not support the identification of UL PDU sets, UE 210 may provide RAN 220 with UE assistance information that indicates that UE 210 is not capable of identifying PDU sets (block 760). In response, RAN 220 may apply fallback or legacy QoS parameters to incoming PDUs from UE 210 (block 770). The QoS parameters may correspond to the fallback or legacy QoS parameters received from SMF 230. As such, when UE 210 indicates that PDU set identification is not supported, RAN 220 may not apply PDU set QoS parameters, such as PSDB. Instead, RAN 220 may apply other (e.g., fallback or legacy) QoS parameters to UL traffic from UE 210. Examples of such parameters may include a packet delay budget, packet error rate, etc. In some implementations, these QoS parameters may be provisioned using an alternative QoS profile (or another type of IE) in the PCC rule.

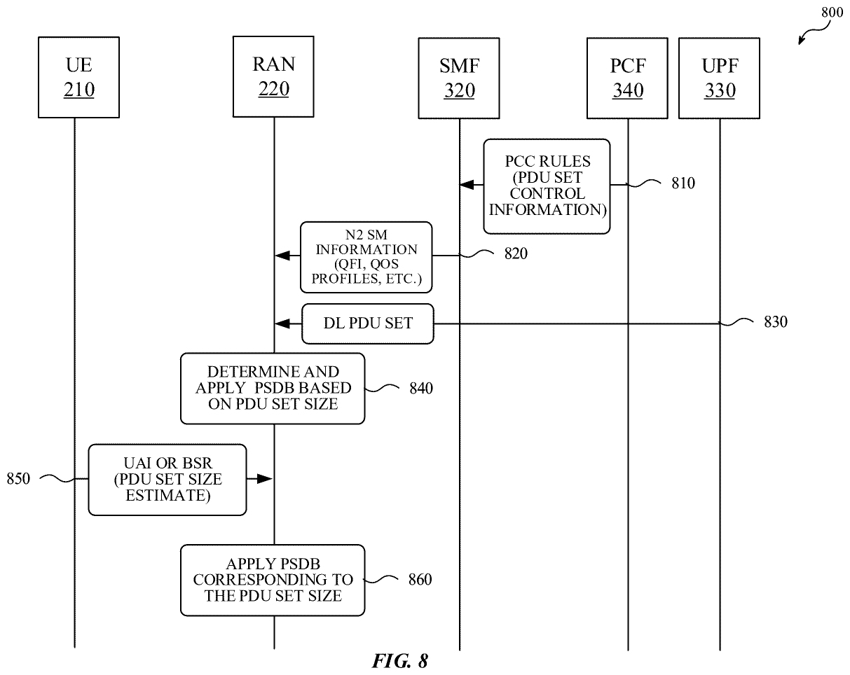

FIG. 8 is a diagram of an example process 800 for applying configurable PSDBs to different PDU sets according to one or more implementations described herein. Process 800 may be implemented by UE 210, RAN 220, SMF 320, UPF 330, and PCF 340. While not shown, the implementation of process 800 may involve one or more additional entities or devices, such as base station 222, AMF 310, and/or AF 350. Additionally, or alternatively, some or all of process 800 may be performed by one or more other systems, devices, or entities, including one or more of the devices of FIGS. 2-3. Further, process 800 may include one or more fewer, additional, differently ordered and/or arranged operations than those shown in FIG. 8. In some implementations, some or all of the operations of process 800 may be performed independently, successively, simultaneously, etc., of one or more of the other operations of process 800. As such, the techniques described herein are not limited to a number, sequence, arrangement, timing, etc., of the operations or processes depicted in FIG. 8.

Process 800 may include a technique for dynamically applying a configurable PSDB to a PDU set. In the DL direction, an SDF may include unmarked or lonely PDUs (i.e., PDUs that could not be identified by UPF 330 as belonging to a PDU set). When UPF 330 receives an unmarked PDU, UPF 330 may still map the unmarked PDU to a PDU set (e.g., based on a protocol description for PDU set identification) and may determine information (e.g., QoS parameters such as a PSDB) about the PDU set. The PDU set information determined by UPF 330 may be based on a pre-configuration of UPF 330. However, inefficiencies may arise when a PSDB is applied to a PDU set that includes only one PDU since a PSDB is typically designed for a PDU set that includes multiple PDUs. Said another way, a PSDB is typically longer than a PDB. A similar issue may arise in scenarios where an application or services generates PDU sets with large variances in the number constituent PDUs. For example, if one PDU set contains 50 PDUs and another PDU set (of the same SDF) contains only 2 PDUs, a single PSDB value defined to accommodate the largest possible PDU set may cause delays for smaller PDU sets of that SDF.

As shown, process 800 may include PCF 340 communicating PCC rules to SMF 320 (810). The PCC rules may include PDU set control information. Examples of PDU set control information may include quality of service parameters, such as a PDU set delay budget, a PDU set error rate, a PDU set integrated handling indication, etc. In some implementations, different sets of PDU set control information may be associated with different transport protocols, QFIs, QoS flows, DRBs, etc. In some implementations, the PDU set control information may include legacy or fallback QoS parameters for scenarios in which UE 210 provides UL traffic without identifying PDU sets. The PDU set control information may also, or alternatively, include rules or procedures for determining and applying a configurable PBDB to PDU set, which may be the same or different for UL and DL traffic.

Process 800 may include SMF 320 providing SM information to RAN 220 (e.g., base station 222, not shown) (block 820). SMF 320 may provide the information via an N2 interface. The information may include QFIs, QoS profiles, protocol descriptions, and/or one or more other types of information. A QoS profile may include QoS parameters for PDU sets, including configurable PSDB values. A PSDB may be configurable as a function of a number of PDUs in a PDU set. A configurable PSDB may better enable RAN 220 to apply appropriate scheduling when numerous PDUs arrive in a DL flow, a UL flow, and/or a combination of DL and UL flows. PSDB value of a configurable PSDB may be dynamically applied (e.g., may be changed) within a QoS flow.

In one example, the PSDB value of a configurable PSDB may be based on a lower threshold value (N1), an upper threshold value (N2), and a number (n) of PDUs in a PDU set. In such a scenario, a first PSDB value may be applied to PDU sets, where 0<n<=N1; and a second PSBD value may be applied to PDU sets, where N1<n<=N2. In another example, a threshold number (N) of PDUs in a PDU set may be defined, and a first PSDB value may be applied when a PDU set is greater than N and a second PSDB value may ae applied when a PDU set is less than N. In such a scenario the threshold number of PDUs in a PDU set may be, for example, specified or indicated by AF 350 or pre-configured per operator policies. In yet another example, the PSDB value applied to a PDU set based on a combination of a fixed value (e.g., a PDU delay budget (PDB) associated with a QoS identifier) and a function of a number (N) of PDUs in the PDU set. For example, the PSDB value for a given PDU set may be equal to: PDB+((N−1)*0.5 ms). The fixed value may be a PDB for a corresponding per-PDU 5QI. In another example, the PSBD value for a given PDU set may be equal to: (N+1) PDB, where fixed value is same as the PDB for an equivalent per-PDU QoS identifier.

Process 800 may include RAN 220 receiving a DL PDU set from UPF (block 330). The DL PDU set may have originated from an external network 250, application server 240, and/or another UE 210. RAN 220 may determine an appropriate PSBD based on a size (e.g., the number of PDUs) of the DL PDU set and may apply the PSDB to the DL PDU set (block 840). The PSBD may be a configurable PSBD as described above. RAN 220 may also, or alternatively, receive UAI, a buffer status report (BSR), or another type of information from UE 210 (block 850). The information may include an indication or estimate of a PDU set size corresponding to UL PDUs that are being communicated, and/or that will be communicated by UE 210 to RAN 220 from UE 210. RAN 220 may determine an appropriate PSBD based on the PDU set size indicated by UE 210 and may apply the PSDB to the corresponding UL PDU set (block 840). RAN 220 may determine the PSDB for the UL PDU set using the same technique applied to the DL PDU set or using a different technique. Accordingly, one or more of the techniques described herein may include solutions for dynamically applying a configurable PSBD to UL and DL QoS flows based on a number of PDUs in a PDU set.

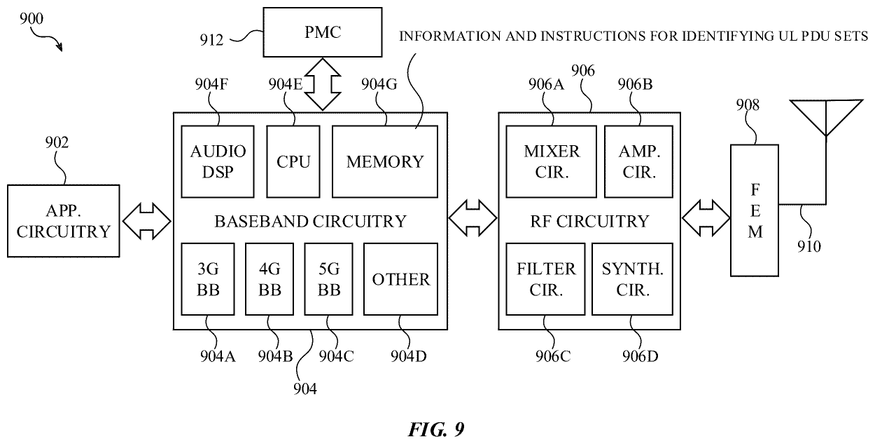

FIG. 9 is a diagram of an example of components of a device according to one or more implementations described herein. In some implementations, device 900 can include application circuitry 902, baseband circuitry 904, RF circuitry 906, front-end module (FEM) circuitry 908, one or more antennas 910, and power management circuitry (PMC) 912 coupled together at least as shown. In some implementations, device 900 can include fewer elements (e.g., a RAN node may not utilize application circuitry 902 and can instead include a processor/controller to process data received from a core network. In some implementations, device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for cloud-RAN (C-RAN) implementations).

Application circuitry 902 can include one or more application processors. For example, application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 900. In some implementations, processors of application circuitry 902 can process data packets received from a core network.

Baseband circuitry 904 can include circuitry such as, but not limited to, one or more single-core or multi-core processors. Baseband circuitry 904 can include one or more baseband processors or control logic to process baseband signals received from a receive signal path of RF circuitry 906 and to generate baseband signals for a transmit signal path of RF circuitry 906. Baseband circuitry 904 can interface with application circuitry 902 for generation and processing of the baseband signals and for controlling operations of RF circuitry 906. For example, in some implementations, baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, 7G, etc.). Baseband circuitry 904 (e.g., one or more of baseband processors 904A-D) can handle various radio control functions that enable communication with one or more radio networks via RF circuitry 906. In other implementations, some or all of the functionality of baseband processors 904A-D can be included in modules stored in memory 904G and executed via a central processing unit (CPU) 904E. The radio control functions can include, but are not limited to, signal modulation/demodulation, encoding/decoding, radio frequency shifting, etc. In some implementations, modulation/demodulation circuitry of baseband circuitry 904 can include Fast-Fourier Transform (FFT), precoding, or constellation mapping/de-mapping functionality. In some implementations, encoding/decoding circuitry of baseband circuitry 904 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 904G can receive and/or store information and instructions for enabling XRM PDU set QoS parameters enhancement as described herein. The information and instructions may enable one or more of the processes, operations, or functions described herein as being performed by UE 210 or RAN 220. For example, the information and instructions may enable UE 210 to identify UL PDU sets based on protocol description information for an XRM application. In another example, the information and instructions may enable UE 210 to request a protocol description from a network device and/or indicate an ability to identify UL PDU sets. Many other aspects and examples are also described herein.

In some implementations, baseband circuitry 904 can include one or more audio digital signal processor(s) (DSP) 904F. Audio DSP 904F can include elements for compression/decompression and echo cancellation and can include other suitable processing elements in other implementations. Components of baseband circuitry 904 can be suitably combined in a single chip, a single chipset, or disposed on a same circuit board in some implementations. In some implementations, some or all of the constituent components of baseband circuitry 904 and application circuitry 902 can be implemented together such as, for example, on a system on a chip (SOC).

In some implementations, baseband circuitry 904 can provide for communication compatible with one or more radio technologies. For example, in some implementations, baseband circuitry 904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 904 is configured to support radio communications of more than one wireless protocol can be referred to as multi-mode baseband circuitry.

RF circuitry 906 can enable communication with wireless networks using modulated electromagnetic radiation through a non-solid medium. In various implementations, RF circuitry 906 can include switches, filters, amplifiers, etc., to facilitate the communication with the wireless network. RF circuitry 906 can include a receive signal path which can include circuitry to down-convert RF signals received from FEM circuitry 908 and provide baseband signals to baseband circuitry 904. RF circuitry 906 can also include a transmit signal path which can include circuitry to up-convert baseband signals provided by baseband circuitry 904 and provide RF output signals to FEM circuitry 908 for transmission.

In some implementations, the receive signal path of RF circuitry 906 can include mixer circuitry 906A, amplifier circuitry 906B and filter circuitry 906C. In some implementations, the transmit signal path of RF circuitry 906 can include filter circuitry 906C and mixer circuitry 906A. RF circuitry 906 can also include synthesizer circuitry 906D for synthesizing a frequency for use by mixer circuitry 906A of the receive signal path and the transmit signal path. In some implementations, mixer circuitry 906A of the receive signal path can be configured to down-convert RF signals received from FEM circuitry 908 based on the synthesized frequency provided by synthesizer circuitry 906D. Amplifier circuitry 906B can be configured to amplify the down-converted signals and filter circuitry 906C can be a low-pass filter (LPF) or band-pass filter (BPF) configured to remove unwanted signals from the down-converted signals to generate output baseband signals. Output baseband signals can be provided to baseband circuitry 904 for further processing. In some implementations, the output baseband signals can be zero-frequency baseband signals, although this may not be a requirement. In some implementations, mixer circuitry 906A of the receive signal path can comprise passive mixers, although the scope of the implementations is not limited in this respect.

In some implementations, mixer circuitry 906A of the transmit signal path can be configured to up-convert input baseband signals based on the synthesized frequency provided by synthesizer circuitry 906D to generate RF output signals for FEM circuitry 908. The baseband signals can be provided by baseband circuitry 904 and can be filtered by filter circuitry 906C. In some implementations, mixer circuitry 906A of the receive signal path and mixer circuitry 906A of the transmit signal path can include two or more mixers and can be arranged for quadrature down conversion and up conversion, respectively. In some implementations, mixer circuitry 906A of the receive signal path and mixer circuitry 906A of the transmit signal path can include two or more mixers and can be arranged for image rejection. In some implementations, mixer circuitry 906A of the receive signal path and mixer circuitry 906A can be arranged for direct down conversion and direct up conversion, respectively. In some implementations, mixer circuitry 906 of the receive signal path and mixer circuitry 906A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 906 can include analog-to-digital converter (ADC) and digital-to-analog converter (DAC) circuitry and baseband circuitry 904 can include a digital baseband interface to communicate with RF circuitry 906.

In some dual-mode implementations, a separate radio integrated circuitry can be provided for processing signals for each spectrum, although the scope of the implementations is not limited in this respect. In some implementations, synthesizer circuitry 906D can be a fractional-N synthesizer or a fractional N/N+1 synthesizer, although the scope of the implementations is not limited in this respect as other types of frequency synthesizers can be suitable. For example, synthesizer circuitry 906D can be a delta-sigma synthesizer, a frequency multiplier, or a synthesizer comprising a phase-locked loop with a frequency divider.

Synthesizer circuitry 906D can be configured to synthesize an output frequency for use by mixer circuitry 906A of RF circuitry 906 based on a frequency input and a divider control input. In some implementations, synthesizer circuitry 906D can be a fractional N/N+1 synthesizer. In some implementations, frequency input can be provided by a voltage-controlled oscillator (VCO). Divider control input can be provided by either baseband circuitry 904 or the applications circuitry 902 depending on the desired output frequency. In some implementations, a divider control input (e.g., N) can be determined from a look-up table based on a channel indicated by the applications circuitry 902.

Synthesizer circuitry 906D of RF circuitry 906 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 906D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 906 can include an in-phase/quadrature (I/Q)/polar converter.

FEM circuitry 908 can include a receive signal path which can include circuitry configured to operate on RF signals received from one or more antennas 910, amplify the received signals and provide the amplified versions of the received signals to RF circuitry 906 for further processing. FEM circuitry 908 can also include a transmit signal path which can include circuitry configured to amplify signals for transmission provided by RF circuitry 906 for transmission by one or more of the one or more antennas 910. In various implementations, the amplification through the transmit or receive signal paths can be done solely in RF circuitry 906, solely in FEM circuitry 908, or in both RF circuitry 906 and FEM circuitry 908.

In some implementations, FEM circuitry 908 can include a transmit/receive switch to switch between transmit mode and receive mode operation. FEM circuitry 908 can include a receive signal path and a transmit signal path. The receive signal path of FEM circuitry 908 can include a low noise amplifier to amplify received RF signals and provide the amplified received RF signals as an output (e.g., to RF circuitry 906). The transmit signal path of FEM circuitry 908 can include a power amplifier to amplify input RF signals (e.g., provided by RF circuitry 906), and one or more filters to generate RF signals for subsequent transmission (e.g., by one or more of one or more antennas 910).

In some implementations, PMC 912 can manage power provided to baseband circuitry 904. In particular, PMC 912 can control power-source selection, voltage scaling, battery charging, or direct current (DC) to DC (DC-to-DC) conversion. PMC 912 can often be included when device 900 is capable of being powered by a battery, for example, when device 900 is included in a UE. PMC 912 can increase the power conversion efficiency while providing desirable implementation size and heat dissipation characteristics.

While FIG. 9 shows PMC 912 coupled only with baseband circuitry 904. However, in other implementations, PMC 912 can be additionally or alternatively coupled with, and perform similar power management operations for, other components such as, but not limited to, application circuitry 902, RF circuitry 906, or FEM circuitry 908.

In some implementations, PMC 912 can control, or otherwise be part of, various power saving mechanisms of device 900. For example, if device 900 is in an RRC_Connected state, where device 900 is still connected to the RAN node as device 900 expects to receive traffic shortly, then device 900 can enter a state known as discontinuous reception mode (DRX) after a period of inactivity. During this state, device 900 can power down for brief intervals of time and thus save power.

If there is no data traffic activity for an extended period of time, then device 900 can transition off to an RRC_Idle state, where device 900 disconnects from the network and does not perform operations such as channel quality feedback, handover, etc. Device 900 can go into a very low power state and device 900 can perform paging where again device 900 periodically can wake up to listen to the network and then power down again. Device 900 may not receive data in this state; in order to receive data, device 900 can transition back to RRC_Connected state.

An additional power saving mode can allow a device to be unavailable to the network for periods longer than a paging interval (ranging from seconds to a few hours). During this time, the device 900 can be unreachable to the network and can power down completely. Any data sent during this time can incur a large delay and device 900 can assume the delay is acceptable.

Processors of application circuitry 902 and processors of baseband circuitry 904 can be used to execute elements of one or more instances of a protocol stack. For example, processors of baseband circuitry 904, alone or in combination, can be used execute Layer 3, Layer 2, or Layer 1 functionality, while processors of baseband circuitry 904 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

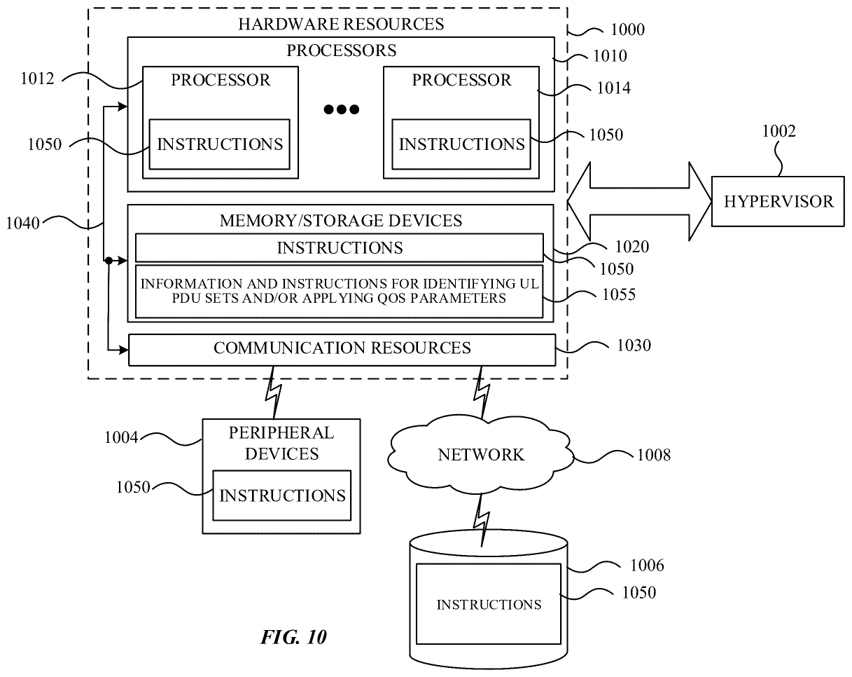

FIG. 10 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors 1010 (or processor cores), one or more memory/storage devices 1020, and one or more communication resources 1030, each of which can be communicatively coupled via a bus 1040. For implementations where node virtualization or network function virtualization is utilized, a hypervisor can be executed to provide an execution environment for one or more network slices/sub-slices to utilize hardware resources 1000. Hardware resources 1000 can interact with hypervisor 1002. For example, hypervisor 1002 can schedule or otherwise manage hardware resource 1000.

Processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1012 and a processor 1014.

Memory/storage devices 1020 can include main memory, disk storage, or any suitable combination thereof. Memory/storage devices 1020 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), flash memory, solid-state storage, etc.

In some implementations, memory/storage devices 1020 receive and/or store information and instructions 1055 for enabling XRM PDU set QoS parameters enhancement as described herein. The information and instructions may enable one or more of the processes, operations, or functions described herein as being performed by UE 210 or RAN 220. For example, the information and instructions may enable UE 210 to identify UL PDU sets based on protocol description information for an XRM application. In another example, the information and instructions may enable UE 210 to request a protocol description from a network device and/or indicate an ability to identify UL PDU sets. Many other aspects and examples are also described herein.

Communication resources 1030 can include interconnection or network interface components or other suitable devices to communicate with one or more peripheral devices 1004 or one or more databases 1006 via a network 1008. For example, communication resources 1030 can include wired communication components (e.g., for coupling via a universal serial bus), cellular communication components, near field communication components, Bluetooth® components (e.g., Bluetooth® Low Energy), Wi-Fi® components, and other communication components.

Instructions 1050A, 1050B, 1050C, 1050D, and/or 1050E can comprise software, a program, an application, an applet, an app, or other executable code for causing at least any of processors 1010 to perform any one or more of the methodologies discussed herein. Instructions 1050 can reside, completely or partially, within at least one of processors 1010 (e.g., within a cache memory), memory/storage devices 1020, or any suitable combination thereof. Furthermore, any portion of instructions 1050A-E can be transferred to hardware resources 1000 from any combination of peripheral devices 1004 or databases 1006. Accordingly, memory of processors 1010, memory/storage devices 1020, peripheral devices 1004, and databases 1006 are examples of computer-readable and machine-readable media.

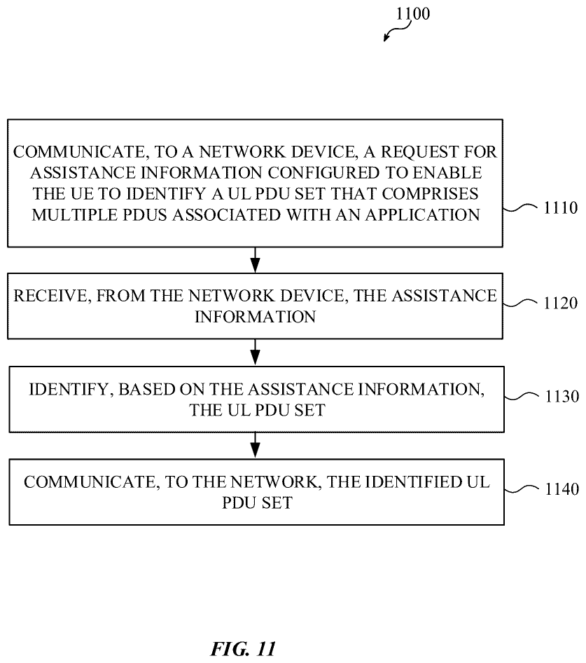

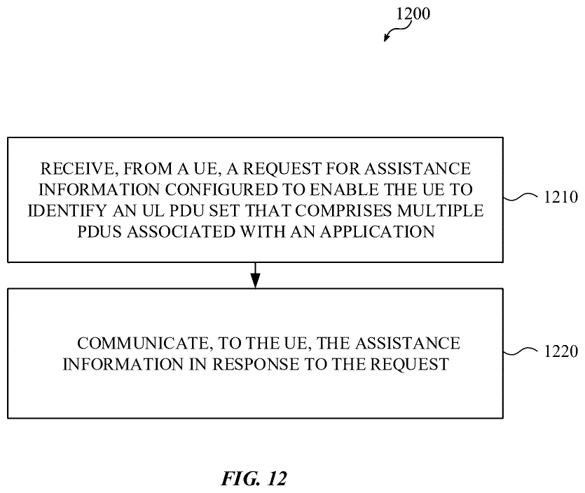

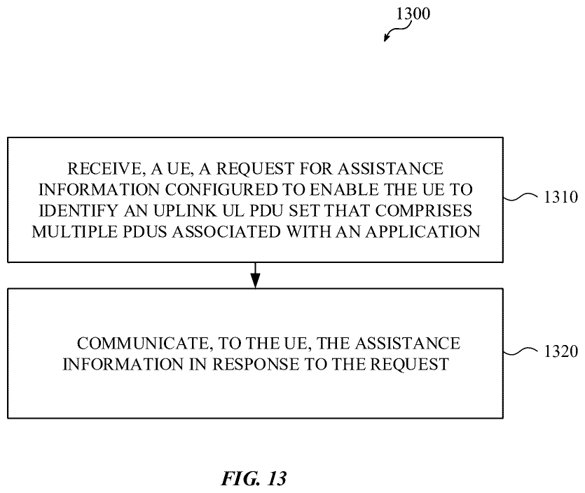

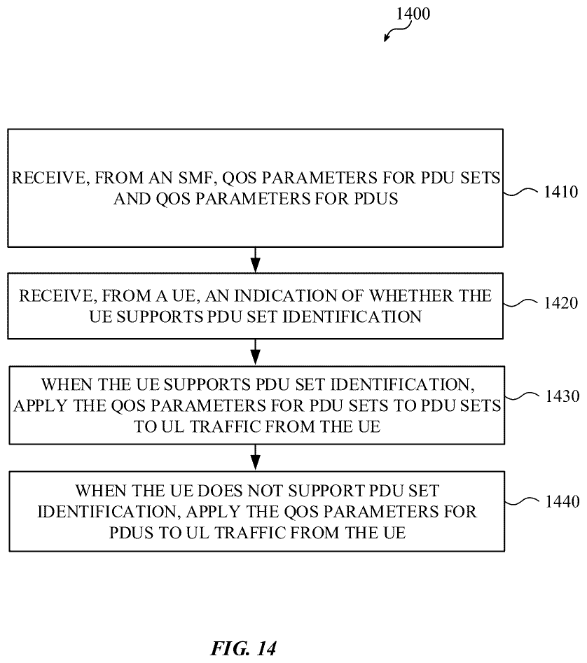

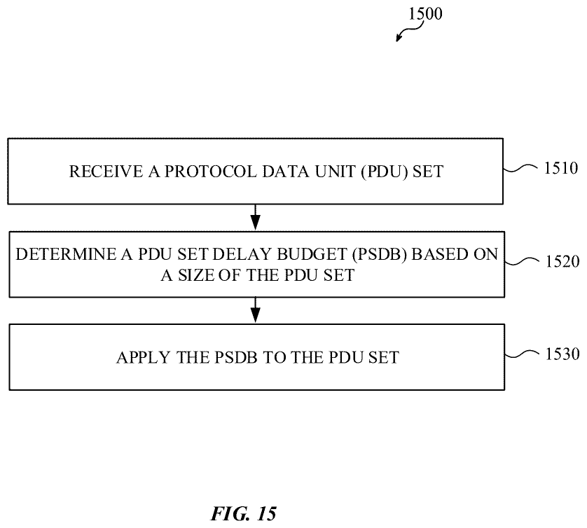

FIGS. 11-15 are diagrams of example process 1100-1500 for PDU set QoS parameters enhancement according to one or more implementations described herein. Processes 1100-1500 may be implemented by UE 210, base station 222, and/or SMF 320. While not shown, the implementation of process 400 may involve one or more additional entities or devices, such as AMF 310, UPF 330, PCF 340, and/or AF 350. Additionally, or alternatively, some or all of example process 1100-1500 may be performed by one or more other systems, devices, or entities, including one or more of the devices of FIGS. 2-3. Further, example process 1100-1500 may include one or more fewer, additional, differently ordered and/or arranged operations than those shown in FIGS. 11-15. In some implementations, some or all of the operations of example process 1100-1500 may be performed independently, successively, simultaneously, etc., of one or more of the other operations of example process 1100-1500. As such, the techniques described herein are not limited to a number, sequence, arrangement, timing, etc., of the operations or processes depicted in FIGS. 11-15.

Example process 1100 may include a UE 210 communicating, to a network device, a request for assistance information configured to enable UE 210 to identify a UL PDU set that comprises multiple PDUs associated with an application (block 1110); receiving, from the network device, the assistance information (block 1120); identifying, based on the assistance information, the UL PDU set (block 1130); and communicating, to the network, the identified UL PDU set (block 1140).

Example process 1200 may include SMF 320 receiving, from a user equipment (UE), a request for assistance information configured to enable the UE to identify an uplink (UL) protocol data unit (PDU) set that comprises multiple PDUs associated with an application (block 1210); and communicating, to the UE, the assistance information in response to the request (1220).

Example process 1300 may include a base station receiving, a user equipment (UE), a request for assistance information configured to enable the UE to identify an uplink (UL) protocol data unit (PDU) set that comprises multiple PDUs associated with an application (block 1310); and communicating, to the UE, the assistance information in response to the request (block 1320).

Example process 1400 may include a base station receiving, from a session management function (SMF), quality of service (QoS) parameters for protocol data unit (PDU) sets and QoS parameters for PDUs (block 1410) receiving, from a user equipment (UE), an indication of whether the UE supports PDU set identification (block 1420); when the UE supports PDU set identification, applying the QoS parameters for PDU sets to uplink (UL) traffic from the UE (block 1430); and when the UE does not support PDU set identification, applying the QoS parameters for PDUs to uplink (UL) traffic from the UE (block 1440).

Example process 1500 may include a base station receiving a protocol data unit (PDU) set (1510); determining a PDU set delay budget (PSDB) based on a size of the PDU set (block 1520); and applying the PSDB to the PDU set (block 1530).

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user device (UE) may comprise: a memory; and one or more processors configured to, when executing instructions stored in the memory, cause the UE to: communicate, to a network device, a request for assistance information configured to enable the UE to identify an uplink (UL) protocol data unit (PDU) set that comprises multiple PDUs associated with an application; receive, from the network device, the assistance information; identify, based on the assistance information, the UL PDU set; and communicate, to the network, the identified UL PDU set.

In example 2, which may also include one or more of the examples described herein, the request is communicated to a session management function (SMF) of a core network (CN), and the assistance information is received from the SMF.

In example 3, which may also include one or more of the examples described herein, the assistance information comprises a protocol description of a real-time transport protocol (RTP).

In example 4, which may also include one or more of the examples described herein, the application comprises an extended reality (XR) and media (XRM) application.

In example 5, which may also include one or more of the examples described herein, the request is communicated during a PDU session establishment procedure or a PDU session modification procedure, and the network device comprises a session management function (SMF) of a core network (CN) or a base station.

In example 6, which may also include one or more of the examples described herein, the assistance information is received in accordance with a UE subscription of a unified data management (UDM) node and at least one policy and charging control (PCC) rule of a policy control function (PCF).

In example 7, which may also include one or more of the examples described herein, the UE is further to: receive, from an SMF, an indication that assistance information is available for a QoS flow associated with a QFI.

In example 8, which may also include one or more of the examples described herein, the request for assistance information includes a quality of service (QoS) flow identifier (QFI).

In example 9, which may also include one or more of the examples described herein, the UE is further to: communicate UE capability information comprising an indication that PDU set identification is supported by the UE.

In example 10, which may also include one or more of the examples described herein, the assistance information is received via a radio recourse control (RRC) message.

In example 11, which may also include one or more of the examples described herein, the assistance information comprises UE assistance information (UAI) and an indication that PDU set identification is not supported by the UE.

In example 12, which may also include one or more of the examples described herein, the UE is further to: communicate a PDU set size to the network device.

In example 13, which may also include one or more of the examples described herein, the UE is further to: communicate the request in response to determining a need for the assistance information.

In example 14, which may also include one or more of the examples described herein, one or more server devices, implementing a session management function (SMF) of a core network (CN), may comprise: a memory; and one or more processors configured to, when executing instructions stored in the memory, cause the one or more server devices to: receive, from a user equipment (UE), a request for assistance information configured to enable the UE to identify an uplink (UL) protocol data unit (PDU) set that comprises multiple PDUs associated with an application; and communicate, to the UE, the assistance information in response to the request.

In example 15, which may also include one or more of the examples described herein, the one or more server devices are further to: determine whether to send the assistance information to the UE based on a UE subscription of a unified data management (UDM) node and at least one policy and charging control (PCC) rule of a policy control function (PCF).

In example 16, which may also include one or more of the examples described herein, the one or more server devices are further to: indicate an availability of the assistance information on a per quality of service (QoS) flow basis.

In example 17, which may also include one or more of the examples described herein, the request is received during a PDU session establishment procedure or a PDU session modification procedure.

In example 18, which may also include one or more of the examples described herein, the assistance information comprises a protocol description of a real-time transport protocol (RTP).

In example 19, which may also include one or more of the examples described herein, a base station may comprise a memory; and one or more processors configured to, when executing instructions stored in the memory, cause the base station to: receive, a user equipment (UE), a request for assistance information configured to enable the UE to identify an uplink (UL) protocol data unit (PDU) set that comprises multiple PDUs associated with an application; and communicate, to the UE, the assistance information in response to the request.

In example 20, which may also include one or more of the examples described herein, the assistance information comprises a protocol description of a real-time transport protocol (RTP).

In example 21, which may also include one or more of the examples described herein, the base station is further to: receive, from a session management function (SMF), the assistance information, a quality of service (QoS) flow identifier (QFI), and QoS profile associated with the application.

In example 22, which may also include one or more of the examples described herein, a base station may comprise a memory; and one or more processors configured to, when executing instructions stored in the memory, cause the base station to: receive, from a session management function (SMF), quality of service (QoS) parameters for protocol data unit (PDU) sets and QoS parameters for PDUs; receive, from a user equipment (UE), an indication of whether the UE supports PDU set identification; when the UE supports PDU set identification, apply the QoS parameters for PDU sets to uplink (UL) traffic from the UE; and when the UE does not support PDU set identification, apply the QoS parameters for PDUs to uplink (UL) traffic from the UE.

In example 23, which may also include one or more of the examples described herein, the QoS parameters for PDU sets and the QoS parameters for PDUs originate from a policy control function (PCF) of a core network (CN).

In example 24, which may also include one or more of the examples described herein, the QoS parameters for PDU sets comprise a PDU set delay budget (PSDB), a PDU set error rate (PSER), and a PDU set integrated handling information (PSIHI).

In example 25, which may also include one or more of the examples described herein, a base station may comprise: a memory; and one or more processors configured to, when executing instructions stored in the memory, cause the base station to: receive a protocol data unit (PDU) set; determine a PDU set delay budget (PSDB) based on a size of the PDU set; and apply the PSDB to the PDU set.

In example 26, which may also include one or more of the examples described herein, the PDU set is uplink (UL) traffic received from a user equipment (UE).

In example 27, which may also include one or more of the examples described herein, the PDU set is downlink (DL) traffic received from a user plane function (UPF) of a core network (CN).

In example 28, which may also include one or more of the examples described herein, the base station is to: determine the size of the PDU set based on a PDU set size estimate from a user equipment (UE).

In example 29, which may also include one or more of the examples described herein, the base station is to: determine the size of the PDU set based on a number of PDUs of the PDU set.

In example 30, which may also include one or more of the examples described herein, the base station is further to: receive, from a session management function (SMF), information for determining a configurable PSBD value, wherein the PSDB is determined based on the size of the PDU set and the information for determining a configurable PSBD value.

In example 31, which may also include one or more of the examples described herein, a method, comprising: communicating, to a network device, a request for assistance information configured to enable the UE to identify an uplink (UL) protocol data unit (PDU) set that comprises multiple PDUs associated with an application; receiving, from the network device, the assistance information; identifying, based on the assistance information, the UL PDU set; and communicating, to the network, the identified UL PDU set.

In example 32, which may also include one or more of the examples described herein, a method, comprising: receiving, from a user equipment (UE), a request for assistance information configured to enable the UE to identify an uplink (UL) protocol data unit (PDU) set that comprises multiple PDUs associated with an application; and communicating, to the UE, the assistance information in response to the request.

In example 33, which may also include one or more of the examples described herein, a method, comprising: receiving, a user equipment (UE), a request for assistance information configured to enable the UE to identify an uplink (UL) protocol data unit (PDU) set that comprises multiple PDUs associated with an application; and communicating, to the UE, the assistance information in response to the request.

In example 34, which may also include one or more of the examples described herein, a method, comprising: receiving, from a session management function (SMF), quality of service (QoS) parameters for protocol data unit (PDU) sets and QoS parameters for PDUs; receiving, from a user equipment (UE), an indication of whether the UE supports PDU set identification; when the UE supports PDU set identification, applying the QoS parameters for PDU sets to uplink (UL) traffic from the UE; and when the UE does not support PDU set identification, applying the QoS parameters for PDUs to uplink (UL) traffic from the UE.

In example 35, which may also include one or more of the examples described herein, a method, comprising: receiving a protocol data unit (PDU) set; determining a PDU set delay budget (PSDB) based on a size of the PDU set; and applying the PSDB to the PDU set.

In example 36, which may also include one or more of the examples described herein, a baseband processor may be configured to communicate, to a network device, a request for assistance information configured to enable the UE to identify an uplink (UL) protocol data unit (PDU) set that comprises multiple PDUs associated with an application; receive, from the network device, the assistance information; identify, based on the assistance information, the UL PDU set; and communicate, to the network, the identified UL PDU set.

In example 37, which may also include one or more of the examples described herein, a computer-readable medium may comprise one or more instructions that when executed by one or more processors may cause the one or more processors to perform one or more of the methods described herein.

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user device (UE), comprising:
a memory; and
one or more processors configured to, when executing instructions stored in the memory, cause the UE to:
communicate, to a network device, a request for assistance information configured to enable the UE to identify an uplink (UL) protocol data unit (PDU) set that comprises multiple PDUs associated with an application;
receive, from the network device, the assistance information;
identify, based on the assistance information, the UL PDU set; and
communicate, to the network, the identified UL PDU set.

2. The UE of claim 1, wherein the request is communicated to a session management function (SMF) of a core network (CN), and the assistance information is received from the SMF.

3. The UE of claim 1, wherein the assistance information comprises a protocol description of a real-time transport protocol (RTP).

4. The UE of claim 1, wherein the application comprises an extended reality (XR) and media (XRM) application.

5. The UE of claim 1, wherein the request is communicated during a PDU session establishment procedure or a PDU session modification procedure, and the network device comprises a session management function (SMF) of a core network (CN) or a base station.

6. The UE of claim 1, wherein the assistance information is received in accordance with a UE subscription of a unified data management (UDM) node and at least one policy and charging control (PCC) rule of a policy control function (PCF).

7. The UE of claim 1, wherein the UE is further to:
receive, from an SMF, an indication that assistance information is available for a QoS flow associated with a QFI.

8. The UE of claim 1, wherein the request for assistance information includes a quality of service (QoS) flow identifier (QFI).

9. The UE of claim 1, wherein the UE is further to:
communicate UE capability information comprising an indication that PDU set identification is supported by the UE.

10. The UE of claim 1, wherein the assistance information is received via a radio recourse control (RRC) message.

11. The UE of claim 1, wherein the assistance information comprises UE assistance information (UAI) and an indication that PDU set identification is not supported by the UE.

12. The UE of claim 1, wherein the UE is further to:
communicate a PDU set size to the network device.

13. The UE of claim 1, wherein the UE is further to:
communicate the request in response to determining a need for the assistance information.

14. One or more server devices, implementing a session management function (SMF) of a core network (CN), comprising:
one or more processors configured to cause the one or more server devices to:
receive, from a user equipment (UE), a request for assistance information configured to enable the UE to identify an uplink (UL) protocol data unit (PDU) set that comprises multiple PDUs associated with an application; and
communicate, to the UE, the assistance information in response to the request.

15. The one or more server devices of claim 14, wherein the one or more server devices are further to:
determine whether to send the assistance information to the UE based on a UE subscription of a unified data management (UDM) node and at least one policy and charging control (PCC) rule of a policy control function (PCF).

16. The one or more server devices of claim 14, wherein the one or more server devices are further to:
indicate an availability of the assistance information on a per quality of service (QoS) flow basis.

17. The one or more server devices of claim 14, wherein the request is received during a PDU session establishment procedure or a PDU session modification procedure.

18. The one or more server devices of claim 14, wherein the assistance information comprises a protocol description of a real-time transport protocol (RTP).

19. A method performed by a base station, the method comprising:
receiving, a user equipment (UE), a request for assistance information configured to enable the UE to identify an uplink (UL) protocol data unit (PDU) set that comprises multiple PDUs associated with an application; and
communicating, to the UE, the assistance information in response to the request.

20. The method of claim 19, wherein the assistance information comprises a protocol description of a real-time transport protocol (RTP).
